(19) United States
(12) Patent Application Publication
(10) Pub. No.: US 2014/0232725 A1
(43) Pub. Date: Aug. 21, 2014

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventor: Satoshi IHARA, Tokyo (JP)

(73) Assignee: FUJIFILM Corporation, Tokyo (JP)

(21) Appl. No.: 14/259,849

(22) Filed: Apr. 23, 2014

Related U.S. Application Data
(63) Continuation of application No. PCT/JP2012/006672, filed on Oct. 18, 2012.

(30) Foreign Application Priority Data
Oct. 26, 2011 (JP) 2011-234625

(51) Int. Cl. G06T 7/00; G06T 11/20

(52) U.S. Cl. CPC G06T 7/0012; G06T 11/206
USPC 345/440

(57) ABSTRACT

A graph estimated to represent hepatic veins is extracted from image data. Shape models representing partial tree structures branched from a point of origin within a tree structure representing a common shape of hepatic veins are obtained. A cost function correlates the graph with the shape models. Whether parts extending from the peaks of correlated graph parts and not correlated with a shape model exist within the extracted graph is judged. Positional data of the peaks are obtained as data representing the position of the point of origin in the case that no such parts exist, or positional data of a node closest to an estimated position of the point of origin, specified by tracing along the nodes of such parts from the peaks to approach the estimated position, is obtained as data representing the position of the point of origin, in the case that such parts exist.

### TECHNICAL FIELD

The present invention is related to an image processing apparatus, an image processing method, and an image processing program for obtaining data that represents the position of a point of origin from image data that represents a predetermined structure, which extends from the point of origin while repeatedly branching.

### BACKGROUND ART

When performing ablative surgical procedures to remove diseased portions that include tumors from organs such as the liver and the lungs, it is necessary to specify blood vessels that are providing nutrients to the tumors and to appropriately determine the portions which are governed by such blood vessels as portions to be removed. This is because the portion of a portal vein that supplies nutrients to a tumor and a region governed by the portal vein, at which there is a possibility that substances to be noted such as cancer cells are being sent, are removed within a range that can maintain hepatic function, in ablative surgery of the liver. For this reason, it is important to perform meticulous simulations of what portions are to be removed prior to surgical procedures. Accordingly, it is necessary to accurately extract tree structures (structures that spread branching repeatedly from a point of origin) of blood vessels that run through the lungs and the liver in order to perform such simulations.

Japanese Unexamined Patent Publication No. 2011-098195 proposes a method for automatically extracting target blood vessel structures from image data. In the method of Japanese Unexamined Patent Publication No. 2011-098195, regions having image characteristics of the target blood vessel structures are extracted from image data. A thinning process is administered on the extracted region, and the obtained thin lines are divided by branching points, predetermined distances, etc., to generate a graph. Thereafter, tree structures of blood vessels are extracted by fitting shape models of tree structures that represent common shapes of the target blood vessel structures to the generated graph.

### DISCLOSURE OF THE INVENTION

When blood vessel structures such as hepatic veins are imaged after injecting a contrast agent density fluctuations of the contrast agent are generated at points of origin constituted by comparatively thick blood vessels. Therefore, there are cases in which a point of origin B is not clearly pictured, as illustrated in the image of FIG. 10. In addition, points of origin are often imaged as the edges of images, and there are cases in which they are outside an imaging range and not pictured in images.

In such cases, a graph is generated from image data only with respect to blood vessel portions excluding the point of origin. Therefore, there is a problem that blood vessel structures cannot be accurately extracted by applying the aforementioned conventional method, which extracts a target blood vessel structure by fitting shape models corresponding to the entirety of the target blood vessel structure to a generated graph, under the presumption that the graph has been generated with respect to the entirety of the target blood vessel structure including the point of origin from image data.

In view of the foregoing circumstances, it is an objective of the present invention to provide an image processing apparatus, an image processing method, and an image processing program which are capable of accurately specifying the position of a point of origin even in the case that the point of origin of a target structure is not sufficiently pictured in image data.

The image processing apparatus of the present invention obtains data that represents the position of a point of origin from image data that represents a predetermined structure, which extends from the point of origin while repeatedly branching, and comprises:

graph extracting means, for extracting a graph, which is estimated to represent the predetermined structure, from the image data;

shape model storing means, in which a plurality of shape models that represent pluralities of partial tree structures that branch from a portion corresponding to the point of origin within a tree structure that represents a common shape of the predetermined structure are stored;

correlating means, for correlating the plurality of shape models with the extracted graph, by determining corresponding points among each of a plurality of nodes that constitute the plurality of shape models and a plurality of nodes that constitute the extracted graph, employing a predetermined cost function; and

point of origin data obtaining means, for judging whether graph parts that extend from the peaks of correlated graph parts and which are not correlated with a shape model are present within the extracted graph, for each graph part which has been correlated with the shape model, (a): obtaining positional data of the peak as data that represents the position of the point of origin in the case that it is judged that no such graph parts are present, and (b): specifying a node closest to an estimated position of the point of origin, which is estimated based on the peaks of all of the correlated graph parts, by tracing along the nodes of the graph parts from the peaks to approach the estimated position, and obtaining positional data of the specified node as data that represents the position of the point of origin, in the case that it is judged that such graph parts are present.

The image processing apparatus may further comprise:

second graph extracting means for extracting a graph that represents the predetermined structure, employing data that represents the position of the point of origin obtained by the point of origin data obtaining means.

Here, the graph is a structure constituted by a node group and an edge group that represents the connective relationships among nodes. The tree structure is a graph having a tree structure. In addition, the peaks of the graph parts which are correlated to the shape models are nodes corresponding to root nodes of the partial tree structures which are represented by the correlated shape models.

In the image processing apparatus, the point of origin data obtaining means may estimate the positions of the central points of the peaks of all of the graph parts which are correlated to each of the plurality of shape models as the estimated position of the point of origin. Alternatively, extrapolations may be obtained with respect to curves or lines of each of the correlated graph parts by a predetermined function, and a region of a predetermined size or a central portion of a position at which the extrapolations converge may be estimated as the estimated position of the point of origin.

In addition, the graph extracting means may detect image characteristics and/or a candidate region having structural characteristics of the predetermined structure, generate a graph by administering a thinning process on the candidate region and dividing the obtained thin lines by branching points, predetermined distances, etc., and extract the generated graph as the graph which is estimated to represent the predetermined structure.

Further, the correlating means may employ an evaluation function, which evaluates the degree of similarity between graph parts, formed by a collection of a plurality of nodes that constitute the graph, correlated to the plurality of nodes that constitute the plurality of shape models, and the plurality of shape models, in an arbitrarily set correlative relationship, as the predetermined cost function. Thereby, the correlating means may correlate the plurality of shape models to the extracted graph, by determining a correlative relationship that achieves maximization of the degree of similarity.

The predetermined structure may be the blood vessels of the lungs, the liver, or the heart. More specifically, the predetermined structure may be pulmonary artier, pulmonary veins, portal veins of the liver, coronary arteries, and hepatic veins.

The image processing method of the present invention is a method that causes the processes performed by the means of the image processing apparatus of the present invention to be executed by at least one computer.

The image processing program of the present invention is a program that causes at least one computer to execute the image processing method of the present invention. The program is provided to users by being recorded on recording media such as a CD-ROM and a DVD, or recorded in a storage of a server computer or a network storage in a downloadable state.

When the image processing apparatus, the image processing method, and the image processing program of the present invention obtain data that represents the position of a point of origin from image data that represents a predetermined structure, which extends from the point of origin while repeatedly branching, a graph which is estimated to represent the predetermined structure is extracted from the image data. A plurality of shape models that represent pluralities of partial tree structures that branch from a portion corresponding to the point of origin within a tree structure that represents a common shape of the predetermined structure, which are stored in advance in a shape model storing means, are obtained. The plurality of shape models are correlated with the extracted graph, by determining corresponding points among each of a plurality of nodes that constitute the plurality of shape models and a plurality of nodes that constitute the extracted graph, employing a predetermined cost function. Whether graph parts that extend from the peaks of correlated graph parts and which are not correlated with a shape model are present within the extracted graph is judged, for each graph part which has been correlated with the shape model. (a) In the case that such graph parts are judged to be not present, positional data of the peaks are obtained as data that represent the position of the point of origin. (b) A node closest to an estimated position of the point of origin, which is estimated based on the peaks of all of the correlated graph parts, is specified by tracing along the nodes of the graph parts from the peaks to approach the estimated position, and positional data of the specified node is obtained as data that represents the position of the point of origin, in the case that it is judged that such graph parts are present. Therefore, the position of the point of origin can be accurately specified even in the case that the point of origin of a target structure is not sufficiently pictured in the image data.

Further, the entirety of the predetermined structure that includes the point of origin can be extracted more accurately than by the aforementioned conventional method, in the case that a graph that represents the predetermined structure is extracted, employing the obtained data that represents the position of the point of origin.

### BRIEF DESCRIPTION OF THE DRAWINGS

FIG. 1 is a diagram that illustrates the schematic structure of an image processing apparatus according to an embodiment of the present invention.

FIG. 2 is a diagram that illustrates an example of image data in which hepatic veins are represented.

FIG. 3 is a diagram that illustrates an example of a graph extracted by a graph extracting means.

FIG. 4 is a diagram that illustrates an example of a shape model stored in a shape model storing means.

FIG. 5 is a diagram that illustrates an example of a correlative relationship selected by a correlating means.

FIG. 6 is a diagram that illustrates the manner in which nodes of an extended graph part are traced to approach an estimated position.

FIG. 7 is a diagram that illustrates an example of a node of which the positional coordinates are obtained as data that represents a point of origin.

FIG. 8 is a diagram that illustrates an example of a case in which an extended graph part is not present in any graph part.

FIG. 9 is a diagram that illustrates an example of a case in which an extended graph part is present at only a portion of graph parts.

FIG. 10 is a diagram that illustrates an example of image data in which the point of origin of hepatic veins is not clearly pictured.

### BEST MODE FOR CARRYING OUT THE INVENTION

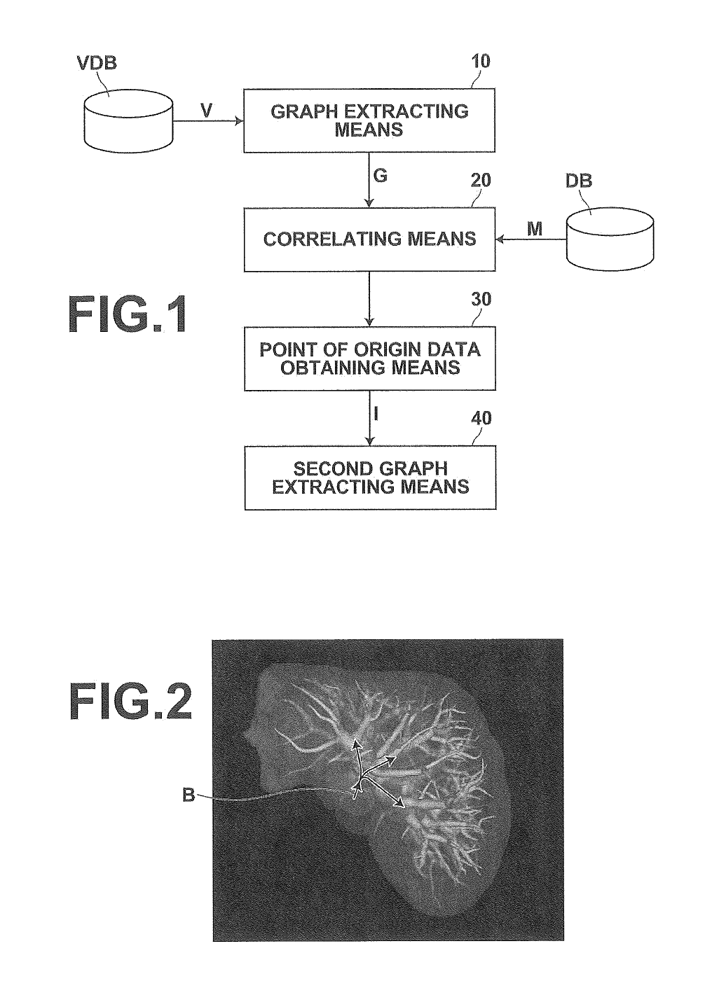

Hereinafter, embodiments of an image processing apparatus, an image processing method, and an image processing program of the present invention will be described with reference to the attached drawings. FIG. 1 is a diagram that schematically illustrates the configuration of an image processing apparatus 1 according to an embodiment of the present invention. Note that the configuration of the image processing apparatus 1 illustrated in FIG. 1 is realized by executing a medical image processing program loaded in an auxiliary memory device on a computer. At this time, the image processing program is recorded in a data recording medium such as a CD-ROM, or distributed via a network such as the Internet, and installed in the computer. The image processing apparatus 1 of FIG. 1 extracts a graph that represents a predetermined structure that spreads and extends by repeatedly branching from a single point of origin B, from image data that represents the predetermined structure. The image processing apparatus 1 is equipped with: a graph extracting means 10; a correlating means 20; a point of origin data obtaining means 30; and a second graph extracting means 40. Hereinafter, a description will be given for a case in which the predetermined structure is hepatic veins such as those illustrated in FIG. 2.

The graph extracting means 10 extracts a graph G which is estimated to represent hepatic veins from image data V that represents the hepatic veins. Specifically, image characteristics of hepatic veins and/or a candidate region R having structural features of hepatic veins are extracted from the image data V. A thinning process is administered on the candidate region R, and the obtained thin lines are divided by branching points, predetermined distances, etc., to generate the graph G, which is extracted as a graph which is estimated to represent hepatic veins. Here, the image data V is three dimensional image data constituted by a large group of two dimensional images which have been obtained by CT apparatuses, MRI apparatuses, ultrasound diagnostic apparatuses, etc., and stored in a data storing means VDB.

First, the graph extracting means 10 calculates the positions of candidate points that constitute the cores of the hepatic veins and the principal axis directions thereof, based on the pixel values of pixels (voxels) that constitute the image data V. Alternatively, the graph extracting means 10 may calculates the positions of candidate points that constitute the cores of the hepatic veins and the principal axis directions thereof by calculating Hessian matrices with respect to the image data V, and by analyzing eigenvalues of the calculated Hessian matrices. Features that represent likelihood of being hepatic veins are calculated for the pixels in the vicinity of each candidate point, and whether the pixels represent hepatic vein regions is classified based on the calculated features. A collection of pixels which have been classified as those representing hepatic vein regions is detected as the candidate region R. Note that classification based on features is performed based on an evaluation function which is obtained in advance by machine learning, for example.

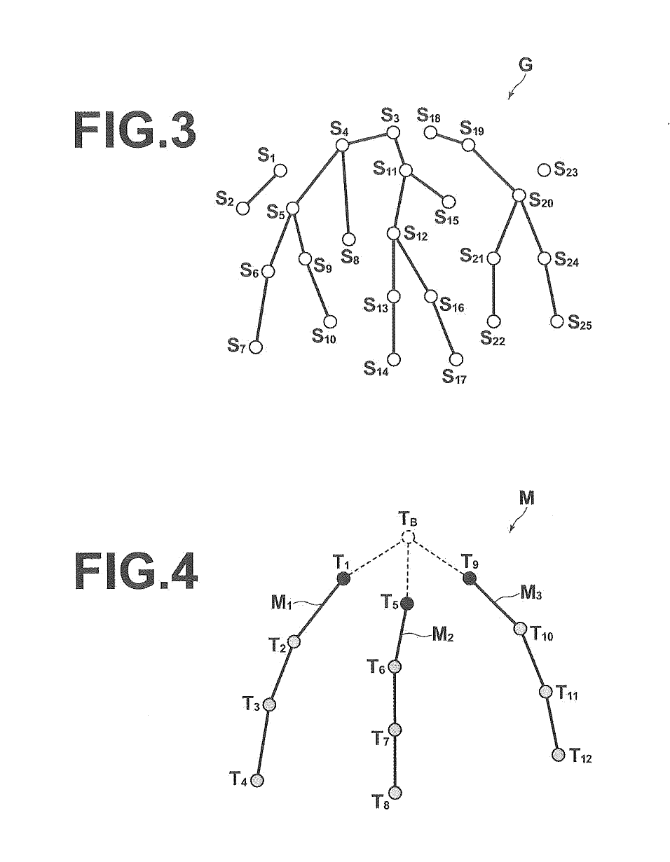

The graph extracting means 10 administers a thinning process on the detected candidate region R by a known method. The lines obtained by the thinning process are divided by branching points, predetermined distances, etc. The branching points and endpoints are defined as candidate points (nodes) Sₚ (p=1 through n; n is the number of candidate points). The graph G is generated by defining edges that connect the candidate points. A graph G such as that illustrated in FIG. 3 is generated in this manner.

The correlating means 20 correlates a shape model M to the graph G by employing a cost function E to determine a plurality of candidate points Sₚ that correspond to each of a plurality of teacher labels (nodes) T_{q} (q=1 through m; m is the number of teacher labels) that constitute the shape models M which are stored in a shape model storing means DB.

Here, the shape model M is a collection of a plurality of shape models Mᵢ (i=1 through L; L is the number of shape models) that represent a plurality of partial tree structures that branch out from a point T_{B} corresponding to the point of origin B within a tree structure that represents a common shape of hepatic veins. Each of the shape models Mᵢ is a tree structured graph having an endpoint (indicated in black in the Figures) toward the point T_{B} as a peak. Here, the tree structure that represents the common shape of the hepatic veins may be obtained by learning a great number of sample images.

The cost function E is an evaluation function, which evaluates the degree of similarity between graph parts, formed by a collection of a plurality of candidate points Sₚ that constitute the graph G, correlated to the plurality of teacher labels T_{q} that constitute the shape models M, and the shape models M, in an arbitrarily set correlative relationship. The cost function E may be expressed by Formula (1) below, which has vector x as a variable. The correlating means 20 correlates the shape models M to the graph G by calculating an optimal solution (correlative relationship) that achieves minimization of the cost function E.

$$E ( x \vert θ ) = {\sum }_{a ∈ R} {θ}_{a} + {\sum }_{( a , b ) ∈ R \times R} {θ}_{ab} \qquad ( 1 )$$

In Formula (1), R represents a collection of correlations among candidate points of a feasible solution x and teacher labels. Θₐ is the cost with respect to an arbitrary correlation (correlations among the candidate points S_{p′} and T_{q′}) belonging to the collection R, and may be expressed by Formula (2) below.

θₐ=−S_{Tq′}(l_{Sp′})−P_{Tq′}(z_{Sp′}) (2)

In Formula (2), S_{Tq′} (l_{Sp′}) represents the degree of matching between the angles of a teacher label T_{q′} and a candidate point S_{p′}, and may be calculated by Formula (3) below. In Formula (3), l_{Tq′} represents the directional vector of the teacher label T_{q′}, and l_{Sp′} represents the directional vector of the candidate point S_{p′}.

S_{Tq′}(l_{Sp′})=|l_{Tq′}·l_{Sp′}| (8)

In Formula (2) P_{Tq′} (Z_{Sp′}) represents the degree of matching between the positions of the teacher label T_{q′} and the candidate point S_{p′} along a Z axis (the direction of the axis of the body). The value of P_{Tq′} (Z_{Sp′}) is obtained by comparing a value which is normalized by dividing the positional coordinate of the teacher label T_{q′} along the Z axis by a common height H_{T} of the liver, and a value which is normalized by dividing the positional coordinate of the candidate point S_{p′} along the Z axis by a height Hₛ of the liver within the image data V. Note that here, only the coordinates along the Z axis are compared against each other. This is because in livers after ablative surgery, portions thereof are removed and there are cases in which fixed coordinates along X and Y axes cannot be defined.

In contrast, such problems do not occur with respect to coordinates along the Z axis.

Meanwhile, θ_{ab} in Formula (1) is the cost with respect to a combination of two correlations a and b (a: correlations among the candidate points S_{p′} and teacher labels T_{q′}; and b: correlations among candidate points S_{p″} and teacher labels T_{q″}) belonging to the collection R, and may be expressed by Formula (4) below.

θ_{ab}=−S_{Tq′Tq″}(X_{Sp′},X_{Sp″}) (4)

Here, S_{Tq′Tq″}(X_{Sp′}, X_{Sp″}) represents the degree of matching between the angle of a line segment that connects a pair of teacher labels (T_{q′}, T_{q″}) and the angle of a line segment that connects a pair of candidate points (S_{p′}, S_{p″}), and can be expressed by Formula (5) below. Here, Xj (J=T_{q′}, T_{q″}, S_{p′}, S_{p″}) represents the positional vectors of each node j.

S_{Tq′Tq″}(X_{Sp′},X_{Sp″})=|(X_{Sp′}−X_{Sp″})ₙₒᵣₘ·(X_{Tq′},X_{Tq″})|(5)

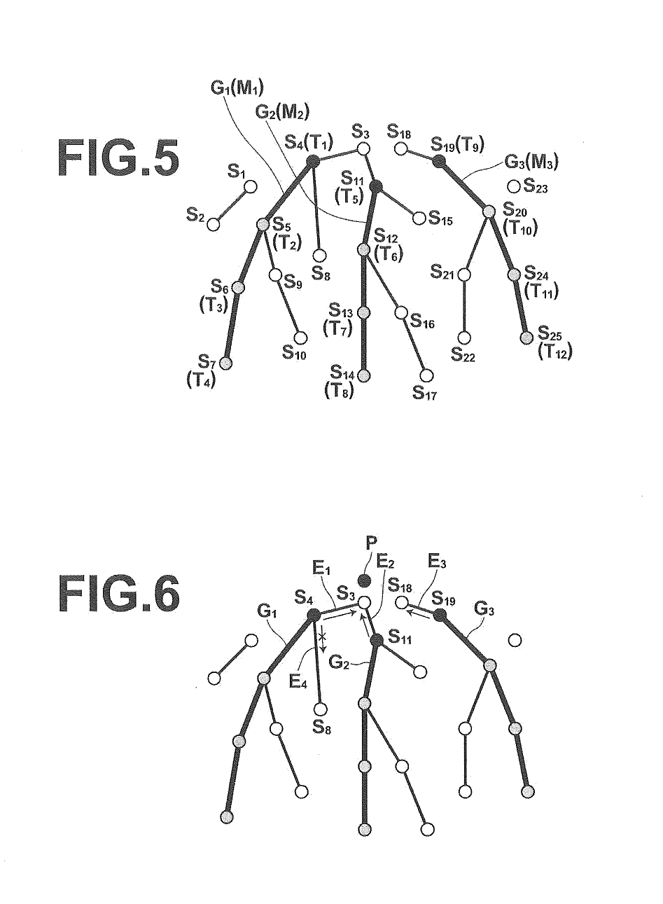

The minimization problem of the cost function E described above can be solved (an optimal solution can be found) by the probability propagation with loops method, or the DD (Dual Decomposition) method. Thereby, a correlative relationship such as that illustrated in FIG. 5 can be selected as the optimal solution with respect to the graph G illustrated in FIG. 3 and the shape model M illustrated in FIG. 4, for example. In the correlative relationship illustrated in FIG. 5, a graph part G₁ is correlated with a shape model M1, a graph part G₂ is correlated with a shape model M2, and a graph part G₃ is correlated with a shape model M3, within the entirety of the graph G.

The point of origin obtaining means 30 obtains data I that represents the point of origin based on the correlative relationship selected by the correlating means 20. First, the point of origin data obtaining means 30 judges whether any graph parts (hereinafter, referred to as “extended graph parts”) that extend from the peak of a graph part Gᵢ and are not correlated with any shape models are present within the entirety of the graph G, for each graph part Gᵢ which is correlated with a shape model Mᵢ.

For example, in the case that the correlating means 20 selects the correlative relationship illustrated in FIG. 5, extended graph parts E₁ and F₄ that extend from a peak S₄ in a graph part G₁, an extended graph part E₂ that extends from a peak S₁₁ are present in a graph part G₂, and an extended graph part E₃ that extends from a peak S₁₉ is present in a graph part G₃, as illustrated in FIG. 6. Therefore, the point of origin data obtaining means 30 will judge that extended graph parts are present for all of the graph parts G₁ through G₃.

Next, the point of origin data obtaining means 30 specifies a node at a position closest to an estimated position P of a predetermined point of origin, by tracing the nodes on the extended graph parts that extend from the peak of each of the graph parts Gᵢ which have been judged as having extended graph parts therein in the aforementioned judgment. Thereby, a node present at a position closest to the estimated position is specified, and positional data of the specified node is obtained as data I that represents the position of the point of origin. Here, the position of a central point of all of the peaks of the graph parts Gᵢ is employed as the estimated position P of the point of origin.

In the case illustrated in FIG. 6, for example, the point of origin data obtaining means 30 first obtains the position of the central point of the peaks S₄, S₁₁, and S₁₉ of the graph parts G₁ through G₃ as the estimated position P of the point of origin. Next, the point of origin data obtaining means 30 traces along the nodes of the extended graph parts that extend from each of the graph parts Gᵢ to approach the estimated position P in order to specify the node present at a position closest to the estimated position P. In the case illustrated in FIG. 6, if the nodes of the extended graph part E₁ that extends from the graph part G₁ and the nodes of the extended graph part E₂ that extends from the graph part G₂ are traced to approach the estimated point P, both of the extended graph parts E₁ and E₂ converge at a node S₃, which is present at a position closest to the estimated position P. Therefore, positional data of the node S₃ is first obtained as the data I that represents the position of the point of origin. With respect to the graph part G₃ as well, a node S₁₈, which is present at a position closest to the estimated position P, is specified by tracing the nodes along the extended graph part E₃ that extends from the peak S₁₉ thereof to approach the estimated position P, and positional data of the node S₁₈ is obtained. That is, the point of origin data obtaining means 30 obtains the positional coordinates of the point S₃ and the point S₁₈ as data I representing the point of origin, as illustrated in FIG. 7.

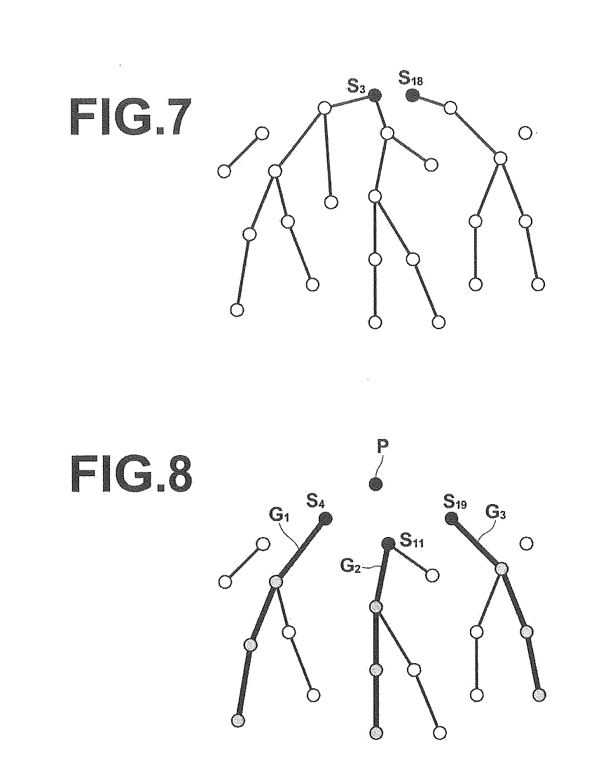

Meanwhile, with respect to graph parts Gᵢ which have been judged to not have extended graph parts present therein, the point of origin data obtaining means 30 obtains positional data of the peaks thereof as the data I that represents the position of the point of origin. For example, in the case that there are no extended graph parts that extend from any of the graph parts G₁ through G₃ as illustrated in FIG. 8, positional data of the peaks S₄, S₁₁, and S₁₉ are obtained as the data I that represent the position of the point of origin.

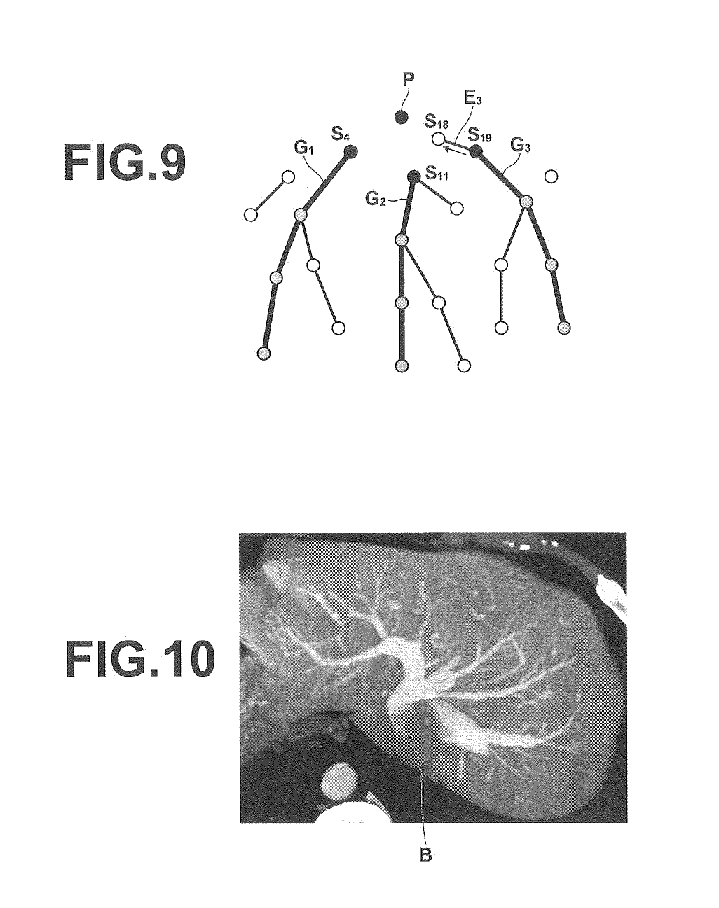

In addition, in the case that an extended graph part that extends from the peak is present only for the graph part G₃ from among all of the graph parts Gᵢ as illustrated in FIG. 9, positional data of the peaks S₄ and S₁₁ of the graph parts G₁ and G₂, for which extended graph parts are not present, are obtained as the data I that represent the position of the point of origin. With respect to the graph part G₃, for which an extended graph part is present, the node S₁₈, which is present at a position closest to the estimated position P, is specified by tracing the nodes along the extended graph part E₃ that extends from the peak S₁₉ thereof to approach the estimated position P, and positional data of the node S₁₈ is obtained as the data I that represents the position of the point of origin. That is, the point of origin data obtaining means 30 the positional data of the points S₄, S₁₁, and S₁₈ are obtained as the data I representing the point of origin.

The second graph extracting means 40 employs the data I that represents the position of the point of origin, obtained by the point of origin data obtaining means 30, to extract a graph that represents hepatic veins from the image data V. Specifically, the second graph extracting means 40 correlates (performs graph fitting) a shape model that represents the entirety of a tree structure that represents the common shape of the hepatic veins with the graph G generated by the graph extracting means 10. Thereby, the second graph extracting means 40 extracts a graph having a tree structure that represents the hepatic veins. This correlating process is performed by calculating an optimal solution (correlative relationship) that achieves minimization of a predetermined cost function in a manner similar to the correlating process administered by the correlating means 20, under the following restrictive conditions. The conditions are that nodes of the graph G positioned at the positional coordinates of one or more points obtained as the data I that represents the position of the point of origin are correlated with a root node (a node that represents the point of origin) or a node positioned in the vicinity of the root node of the shape model.

As described above, in the image processing apparatus, the image processing method, and the image processing program of the present embodiment, the graph extracting means 10 extracts the graph G which is estimated to represent the predetermined structure from the image data V. The correlating means 20 obtains a plurality of shape models Mᵢ that represent pluralities of partial tree structures that branch from portions corresponding to the point of origin within tree structures that represent common shapes of the hepatic veins, which are stored in advance in the shape model storing means DB. The plurality of shape models Mᵢ are correlated with the extracted graph G, by determining corresponding points among each of a plurality of nodes T_{q} that constitute the plurality of shape models Mᵢ and a plurality of nodes Sₚ that constitute the extracted graph G, employing the predetermined cost function E. The point of origin data obtaining means 30 judges Whether graph parts Gᵢ that extend from the peaks of correlated graph parts and which are not correlated with a shape model are present within the extracted graph, for each graph part Gᵢ which has been correlated with the shape model. (a) In the case that such graph parts are judged to be not present, positional data of the peak is obtained as data I that represents the position of the point of origin. (b) In the case that it is judged that such graph parts are present, a node closest to the estimated position P of the point of origin based on the peaks of all of the correlated graph parts is specified by tracing along the nodes of the graph parts from the peaks to approach the estimated position P, and positional data of the specified node is obtained as data I that represents the position of the point of origin. That is, the data I that represents the position of the point of origin is not obtained by utilizing the image data in which the point of origin is pictured in the image data V, but by utilizing the image data in which the branched distal portions of the structures are pictured. Therefore, the position of the point of origin can be accurately specified even in the case that the point of origin of a target structure is not sufficiently pictured in the image data.

The embodiment described above is an example in which the second graph extraction means 40 is provided. However, this configuration is not strictly necessary, and may be provided as necessary.

In addition, in the above embodiment, a case was described in which the point of origin data obtaining means 30 obtains the positional data of all of a plurality of nodes that were traced to as data I that represent the position of the point of origin, in the case that tracing the nodes of extended graph parts that extend from the peaks of each graph part results in a different node for each graph part, that is, the result of tracing does not converge to a single node. However, a configuration may be adopted, in which a node from among such a plurality of nodes present at a position closest to the estimated position P is further specified, and positional data of only the single specified node is obtained as data I that represents the point of origin.

Further, in the above embodiment, a case has been described in which the predetermined structure is hepatic veins. However, the predetermined structure may be any structure that spreads and extends from a single point of origin while branching repeatedly. Examples of such structures include blood vessels of the lungs or the heart, the portal vein of the liver, and coronary arteries.

What is claimed is:

1. An image processing apparatus that obtains data that represents the position of a point of origin from image data that represents a predetermined structure, which extends from the point of origin while repeatedly branching, comprising:
graph extracting means, for extracting a graph, which is estimated to represent the predetermined structure, from the image data;
shape model storing means, in which a plurality of shape models that represent pluralities of partial tree structures that branch from a portion corresponding to the point of origin within a tree structure that represents a common shape of the predetermined structure are stored;
correlating means, for correlating the plurality of shape models with the extracted graph, by determining corresponding points among each of a plurality of nodes that constitute the plurality of shape models and a plurality of nodes that constitute the extracted graph, employing a predetermined cost function; and
point of origin data obtaining means, for judging whether graph parts that extend from the peaks of correlated graph parts and which are not correlated with a shape model are present within the extracted graph, for each graph part which has been correlated with the shape model, obtaining positional data of the peak as data that represents the position of the point of origin in the case that it is judged that no such graph parts are present, and specifying a node closest to an estimated position of the point of origin, which is estimated based on the peaks of all of the correlated graph parts, by tracing along the nodes of the graph parts from the peaks to approach the estimated position, and obtaining positional data of the specified node as data that represents the position of the point of origin, in the case that it is judged that such graph parts are present.

2. An image processing apparatus as defined in claim 1, further comprising:
second graph extracting means for extracting a graph that represents the predetermined structure, employing data that represents the position of the point of origin obtained by the point of origin data obtaining means.

3. An image processing method for obtaining data that represents the position of a point of origin from image data that represents a predetermined structure, which extends from the point of origin while repeatedly branching, comprising:
extracting a graph, which is estimated to represent the predetermined structure, from the image data;
obtaining a plurality of shape models that represent pluralities of partial tree structures that branch from a portion corresponding to the point of origin within a tree structure that represents a common shape of the predetermined structure, which are stored in advance in a shape model storing means;
correlating the plurality of shape models with the extracted graph, by determining corresponding points among each of a plurality of nodes that constitute the plurality of shape models and a plurality of nodes that constitute the extracted graph, employing a predetermined cost function;
judging whether graph parts that extend from the peaks of correlated graph parts and which are not correlated with a shape model are present within the extracted graph, for each graph part which has been correlated with the shape model;
obtaining positional data of the peak as data that represents the position of the point of origin in the case that it is judged that no such graph parts are present; and
specifying a node closest to an estimated position of the point of origin, which is estimated based on the peaks of all of the correlated graph parts, by tracing along the nodes of the graph parts from the peaks to approach the estimated position, and obtaining positional data of the specified node as data that represents the position of the point of origin, in the case that it is judged that such graph parts are present.

4. An image processing method as defined in claim 3, further comprising:
extracting a graph that represents the predetermined structure, employing the obtained data that represents the position of the point of origin.

5. A computer readable medium, in which an image processing program for obtaining data that represents the position of a point of origin from image data that represents a predetermined structure, which extends from the point of origin while repeatedly branching, is stored, the program causing a computer to execute the procedures of:
extracting a graph, which is estimated to represent the predetermined structure, from the image data;
obtaining a plurality of shape models that represent pluralities of partial tree structures that branch from a portion corresponding to the point of origin within a tree structure that represents a common shape of the predetermined structure, which are stored in advance in a shape model storing means;
correlating the plurality of shape models with the extracted graph, by determining corresponding points among each of a plurality of nodes that constitute the plurality of shape models and a plurality of nodes that constitute the extracted graph, employing a predetermined cost function;
judging whether graph parts that extend from the peaks of correlated graph parts and which are not correlated with a shape model are present within the extracted graph, for each graph part which has been correlated with the shape model;
obtaining positional data of the peak as data that represents the position of the point of origin, in the case that it is judged that no such graph parts are present; and
specifying a node closest to an estimated position of the point of origin, which is estimated based on the peaks of all of the correlated graph parts, by tracing along the nodes of the graph parts from the peaks to approach the estimated position, and obtaining positional data of the specified node as data that represents the position of the point of origin, in the case that it is judged that such graph parts are present.

6. A recording medium as defined in claim 5, wherein the image processing program further comprises the procedure of:
extracting a graph that represents the predetermined structure, employing the obtained data that represents the position of the point of origin.
